(19) United States
(12) Patent Application Publication
(10) Pub. No.: US 2007/0017780 A1
(43) Pub. Date: Jan. 25, 2007

(54) Transfer and distribution conveyor system

(75) Inventor: Louis Faucher, Beauce (CA)

Correspondence Address: OGILVY RENAULT LLP, 1981 MCGILL COLLEGE AVENUE, SUITE 1600, MONTREAL, QC, H3A2Y3, CA

(73) Assignee: MEKANIKA INC.

(21) Appl. No.: 11/184,844

(22) Filed: Jul. 20, 2005

(51) Int. Cl. B65G 47/26

(52) U.S. Cl. 198/456

(57) ABSTRACT

A transfer and distribution conveyor system is described. The transfer conveyor system is provided with a reciprocating discharge support platform for discharging by gravity a group of elongated articles, such as floorboards, conveyed transversely of the support platform. The group of articles fall onto a conveyor belt which is oriented transversely, whereby to discharge the group of articles axially with the boards oriented in a spaced-apart relationship. A discharge conveyor is also described, which engages elongated articles which are conveyed laterally, whereby to displace them one at a time axially in end-to-end relationship whereby to feed two or more packaging stations. The packaging stations are fed by a single-feed conveyor which receives these axially aligned articles and which is supported above two or more distribution conveyors, which feed respective ones of sorting and bundling stations. The discharge end of the feed conveyor is displaceable over the distribution conveyors, whereby to continuously feed articles to the distribution conveyors in substantially equal amounts.

### TECHNICAL FIELD

The present invention relates to transfer and distribution conveyor which conveys articles laterally and transfers them axially, and which is also capable of distributing the axially aligned articles to two or more distribution conveyors associated with sorting and bundling stations.

### BACKGROUND ART

In the manufacturing of floorboards, for example, boards need to be transported by conveyors for their sorting and bundling. This transportation of floorboards usually takes place from the jointer machines which form the tongues and grooves in these boards and cut the boards at varying lengths, whereby to eliminate sections of boards which are not usable. The boards may then require to be transported to spray machines or coloring machines, where a surface finish is applied to a surface of the boards. From those machines, the boards are again conveyed to other stations, such as sorting and bundling stations, where various grades of boards are separated, and each of these grades needs to be bundled with boards of varying lengths. Accordingly, one can appreciate that these boards need to be manipulated many times from cutting, jointing, finishing and bundling. This necessitates excessive personnel and irregular conveyor lines to effect the board transfers and reloading, and then to feed sorting and bundling stations.

There is a need to provide a conveyor system which is more efficient in transferring and distributing elongated articles, such as floorboards, and which occupy less floor space and wherein the transportation of these boards can be effected at a higher speed and in a more efficient manner.

### SUMMARY OF INVENTION

It is a feature of the present invention to provide transfer and distribution conveyors which provide the above-mentioned need.

It is another feature of the present invention to provide a transfer conveyor system wherein boards conveyed laterally are transferred in groups by a reciprocating discharge support platform of the conveyor onto a belt conveyor, wherein the group of boards are re-oriented and discharged axially.

Another feature of the present invention is to provide a supply conveyor system having a discharge conveyor for engaging individual ones of articles transported laterally and onto a single-feed conveyor capable of feeding two or more sorting and bundling stations.

Another feature of the present invention is to provide a feed conveyor system having a single-feed conveyor associated with distribution conveyors and wherein the discharge end of the feed conveyor is displaceable to feed elongated articles, such as floorboards, to each of the distribution conveyors to feed the sorting and bundling stations.

According to the above features, from a broad aspect, the present invention provides a transfer conveyor system for transferring conveyed articles from a lateral conveyed position to an axial conveyed position. The transfer conveyor system has a reciprocating discharge support platform for discharging, by gravity, a group of articles conveyed by pusher bars of a continuous-feed conveyor. The pusher bars are disposed in spaced alignment and displaceable over the discharge support platform. The articles are discharged by gravity during a retracting displacement of the discharge support platform and onto a conveyor belt oriented transversely to a direction of travel of the pusher bars wherein the group of discharged articles are conveyed axially in a spaced-apart relationship. Means is provided to reciprocate the support platform.

According to a further broad aspect of the present invention, there is provided a distribution conveyor system for feeding elongated articles to two or more sorting and packaging stations. The system comprises a continuous supply conveyor for conveying the articles by pusher bars oriented laterally in spaced parallel relationship. A discharge conveyor is provided for engaging individual ones of the articles and displacing them axially from the supply conveyor onto a single-feed conveyor wherein the articles are conveyed end to end. The feed conveyor has a discharge end and is supported elevated above two or more distribution conveyors, each of which is associated with a respective one of the two or more packaging stations. Displaceable support means is provided for displacing at least the discharge end of the feed conveyor to discharge one or more of the articles on a receiving end of a selected one of the distribution conveyors.

According to a still further broad aspect of the present invention, there is provided a feed conveyor system for feeding floorboards to two or more sorting and bundling stations. The system comprises a single-feed conveyor having a board receiving end and board discharge end. Means is provided to position boards of varying lengths in spaced-apart end-to-end relationship on the feed conveyor receiving end. Distribution conveyors are disposed side by side and associated with a respective one of the sorting and bundling stations. Support means is provided for supporting the feed conveyor elevated above the distribution conveyors. Displacement means is provided for displacing at least a portion of the feed conveyor discharge end above the distribution conveyors for feeding boards thereto to supply the sorting and bundling stations. Detection means detects boards conveyed by the feed conveyor. Control means is associated with the detection means to control the operation of the displacement means.

### BRIEF DESCRIPTION OF DRAWINGS

A preferred embodiment of the present invention will now be described with reference to the accompanying drawings in which:

FIG. 1 is a perspective view of a transfer conveyor system constructed in accordance with the present invention, and wherein the reciprocating discharge support platform is at a board group receiving position;

FIGS. 2A, 2B and 2C are views similar to FIG. 1, but showing the reciprocating discharge support platform before and after its discharge of the articles herein floor boards on a discharge conveyor;

FIG. 3 is a side view of the discharge end section of the transfer conveyor;

FIG. 4 is a top view illustrating a sorting and packaging arrangement for packaging floorboards which are conveyed thereto by a single-feed conveyor, which is fed board oriented axially by a discharge conveyor of a main conveyor system, with the main conveyor system and a discharge conveyor oriented in a single line;

FIG. 5 is a side view illustrating the position of the feed conveyor relative to the distribution conveyors;

FIG. 6 is a top view, in simplified form, illustrating the relationship of the continuous supply conveyor and the discharge conveyor which discharges articles, such as floorboards, axially;

FIG. 7 is a simplified side view illustrating the construction of a discharge conveyor;

FIG. 8 is a fragmented end view showing in simplified form one embodiment of a displacement means for displacing the single-feed conveyor discharge end above two or more distribution conveyors; and

FIG. 9 is a schematic drawing illustrating how the elongated articles, such as floorboards, are discharged from the feed conveyor onto the distribution conveyor, and a detection means associated therewith.

### DESCRIPTION OF PREFERRED EMBODIMENTS

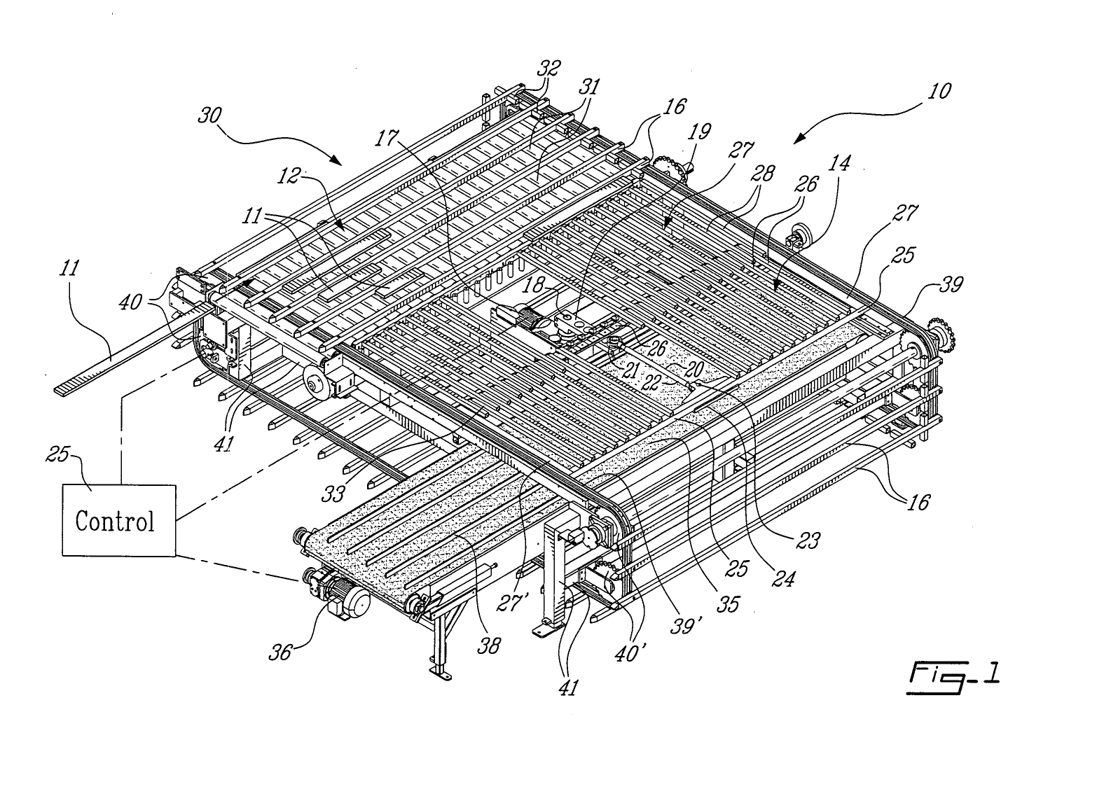

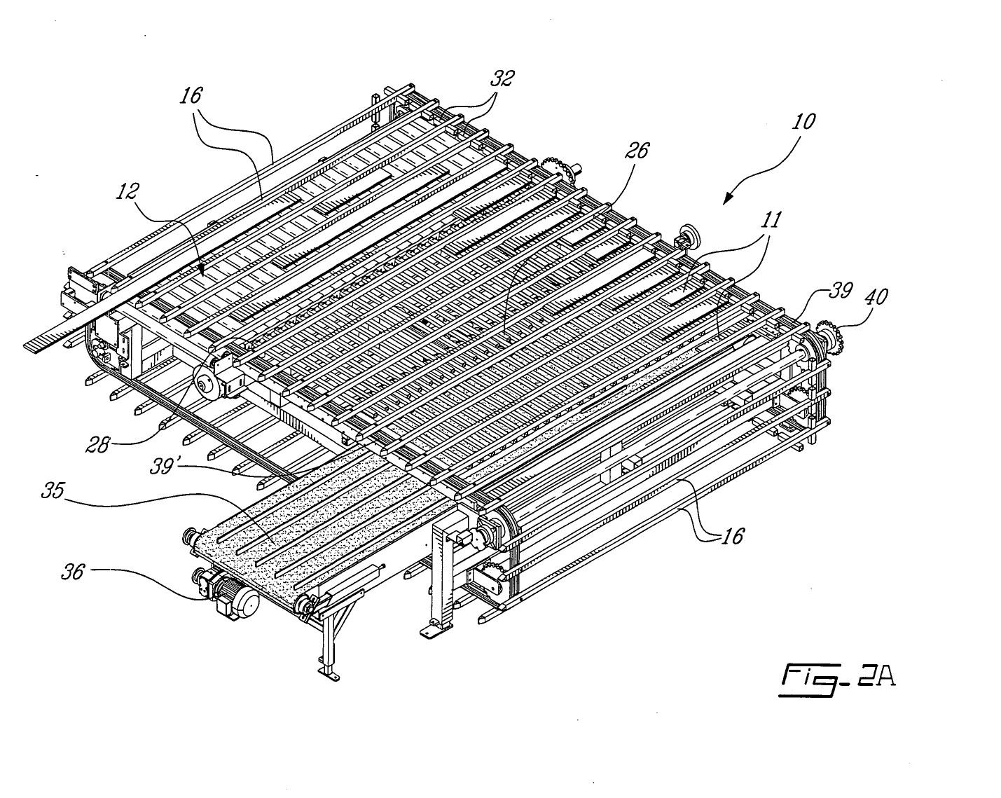

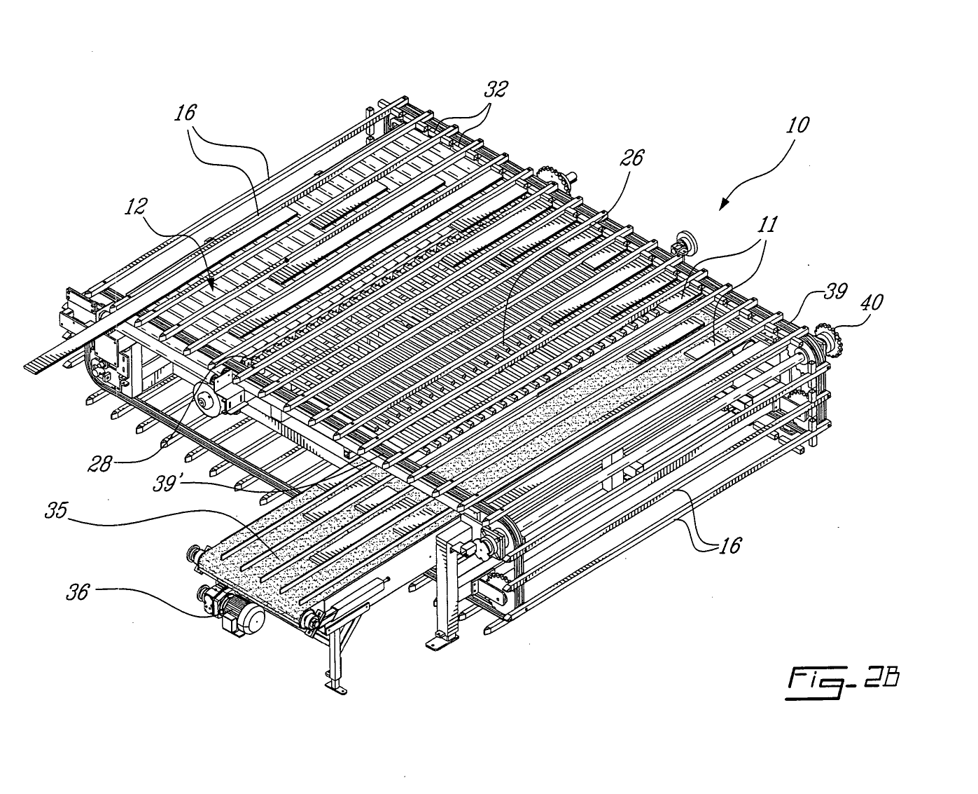

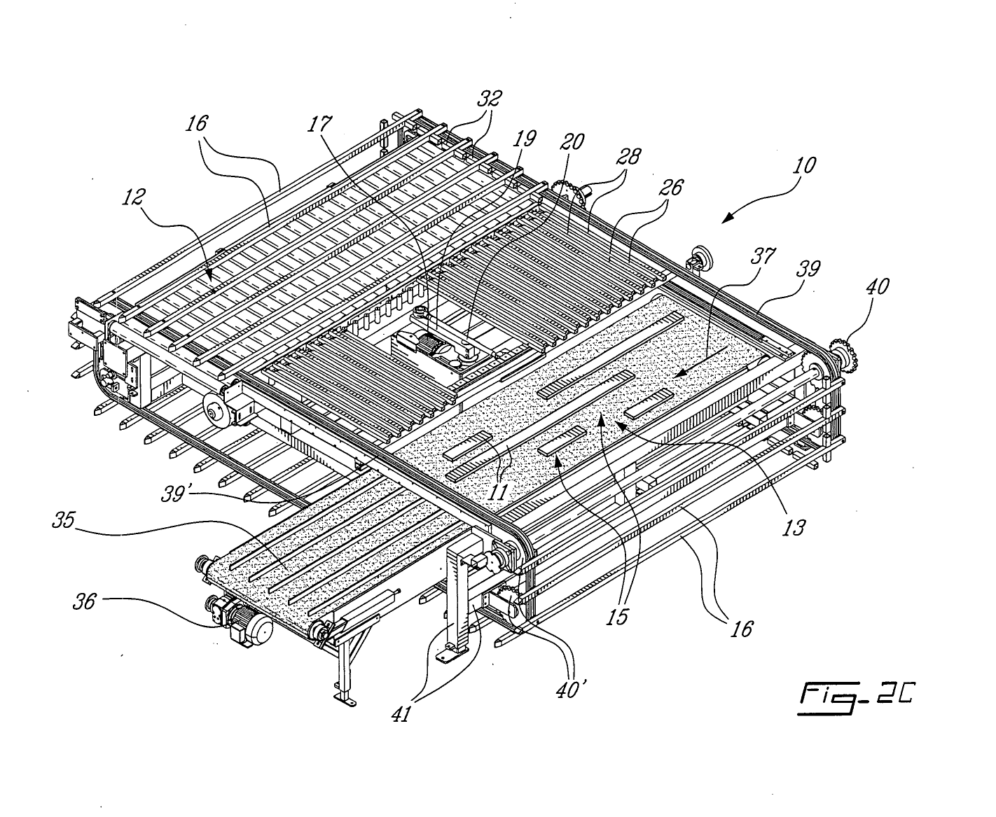

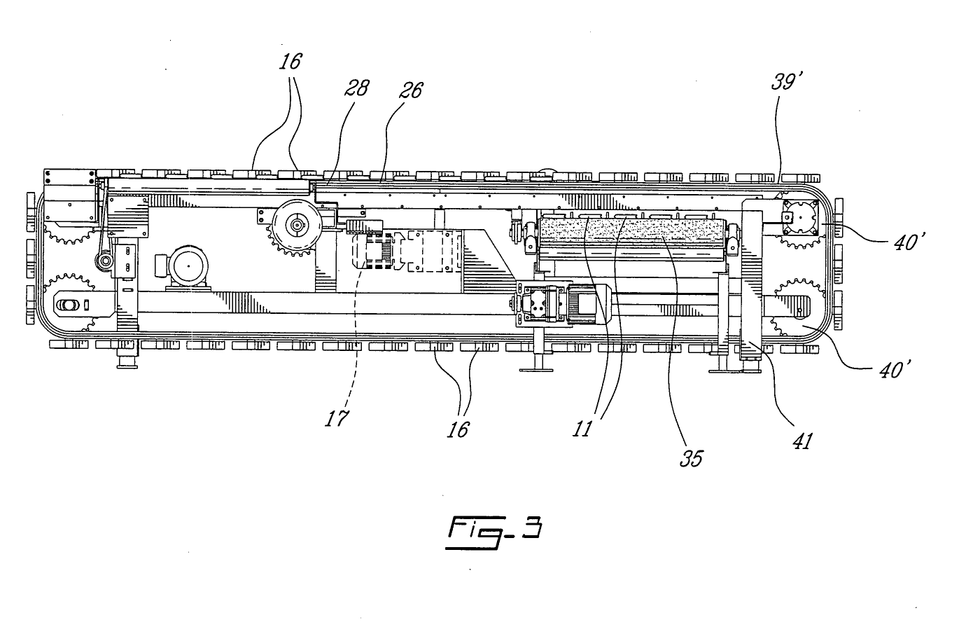

Referring now to the drawings, and more particularly to FIGS. 1 to 3, there is shown generally at 10 the transfer conveyor system of the present invention for transferring conveyed elongated articles, such as floorboards 11, from a lateral conveyed position, as illustrated at 12, to an axially conveyed position 13, as shown in FIGS. 2A to 2C. The transfer conveyor system 10 is provided with a reciprocating discharge support platform 14 for discharging by gravity a group of articles, such as shown at 15 in FIGS. 2A to 2C, conveyed by pusher bars 16 over the discharge support platform 14.

The discharge support platform 14 is reciprocated from its support position, as shown in FIG. 2A, to its discharge position, as shown in FIGS. 2B and 2C, by a reciprocating means which is herein constituted by a servomotor 17, provided with an output driveshaft 18, to which is connected a crank arm 19. The crank arm 19 has a portion thereof immovably secured to the output shaft 18 and a pivotal link arm 20, which is pivotally connected at one, end 21 to a free end of the crank arm 19. It is connected at an opposed end 22 to a pivot connection 23 of a connector 24. The connector 24 is secured to an outermost transverse frame member 25 of a rectangular frame of the support platform 14 formed by frame member 25 and 26, and opposed lateral frames 27 and 27′. The crank arm is displaced about the output shaft 18 at a variable speed, with the motor 17 being controlled by a controller device 25. The variable speed causes the reciprocating platform 14 to be quickly pulled back to release by gravity a plurality of boards 11 supported thereby, and then to re-advance at a speed substantially constant with the displacement speed of the pusher bars 16 whereby to support oncoming boards displaced by these pusher bars, which are not arrested during the discharge cycle of the reciprocating platform. Accordingly, the discharge is very rapid.

As herein shown, the reciprocating platform has a support surface constituted by a plurality of equidistantly spaced elongated support rods 26, secured to the rectangular frame members 25, 26, 27 and 27′, and extend axially of the feed conveyor and transversely to the pusher bars 16, whereby to support the boards 12 conveyed thereon by the pusher bars.

An article support section 27 is disposed adjacent and upstream of the reciprocating discharge support platform 14 and disposed in a common plane therewith for supporting a next oncoming group of articles, herein boards 17, to be discharged by the reciprocating discharge support platform. This article support section 27 is comprised of a plurality of equidistantly spaced elongated stationary support rods 28, which are offset from the support rods 26 of the reciprocating support platform 14, wherein to permit displacement of the support rods of the discharge support platform therebetween when retracted by the crank arm of the servomotor 17. The support rods 28 and 26 intermesh.

Although, in the present embodiment, a servomotor and crank arm arrangement is shown for displacing the reciprocating discharge platform, it is within the ambit of the present invention to cover other such reciprocating displacement devices, such as a pneumatic system which operates a cylinder, for example.

The continuous-feed conveyor system 10 is provided with an article loading section 30 upstream of the article support section 27 for receiving articles, herein floorboards 11, onto the loading section 30 and oriented transversely of the feed conveyor. These articles are fed one at a time between the pusher bars 16. Article support means in the form of transversely oriented support rollers 31 are secured stationary under the pusher bars 16 and oriented transversely thereto. The support rollers facilitate the sliding displacement of the floorboards 11 ejected between the pusher bars. Accordingly, these floorboards can be located at any position between and along the pusher bars, as shown in FIG. 1. The support means can also be constituted by a flat support plate or other suitable stationary support means under the pusher bars at the article loading section. As also herein shown, these floorboards are of varying lengths. They are also of varying grade or quality, such as boards of clear wood, veins or those containing knots. Stopper bars 32 are also connected to individual ones of the pusher bars at an end remote from the loading end to arrest the forward movement of the boards between the pusher bars. The other end of the pusher bars is unobstructed and constitutes a receiving end for the boards. Boards can also be fed automatically to the receiving end, or manually. Such conveyor is normally fed from a discharge end of a jointing machine which forms tongues and grooves in the boards.

As shown in FIGS. 1 to 3, the reciprocating discharge platform 14 is retracted very quickly through a variable cycle, whereby it is returned to support the next oncoming board of a next group of boards in support engagement. In order to do this, the discharge support platform must be retracted during a time period which is shorter than the displacement time between adjacent pusher bars 16, whereby the platform can be retracted and returned to supportingly engage the articles of the next oncoming group of articles. This sequence is very rapid. The support platform can discharge up to six boards at a time onto the discharge belt conveyor 35, the speed of which is also controlled by the controller device 25. The drive motor is illustrated at 36. It is pointed out that boards are transported by the pusher bars at a rate of about 175 to about 180 boards per minute. To do so, the controller 25 controls the drives of the supply conveyor, the discharge belt conveyor 35, and the servomotor 17, all in synchronism.

As shown in FIGS. 2A to 2C, the boards 12 are axially aligned on the discharge belt conveyor, which is rotated in the direction of arrow 37, and these boards are discharged from under the reciprocating platform 14 and onto a transfer conveyor 38 or other transfer means to maintain the group of boards oriented in a substantially spaced, side-by-side relationship.

As herein illustrated, the continuous-feed conveyor 10 is comprised of a pair of spaced-apart endless belts 39 and 39′, which are trained about a driven and idle sprockets 40 and 40′ respectively, secured to a rectangular support frame 41. The pusher bars 19 are connected to the belts 39 and 39′, and extend transversely thereacross. The belts 39 and 39′ are displaced in upper and lower spaced parallel paths by the sprockets. The speed of the conveyor is, of course, controlled by the controller device 25 and in synchronism, as previously described.

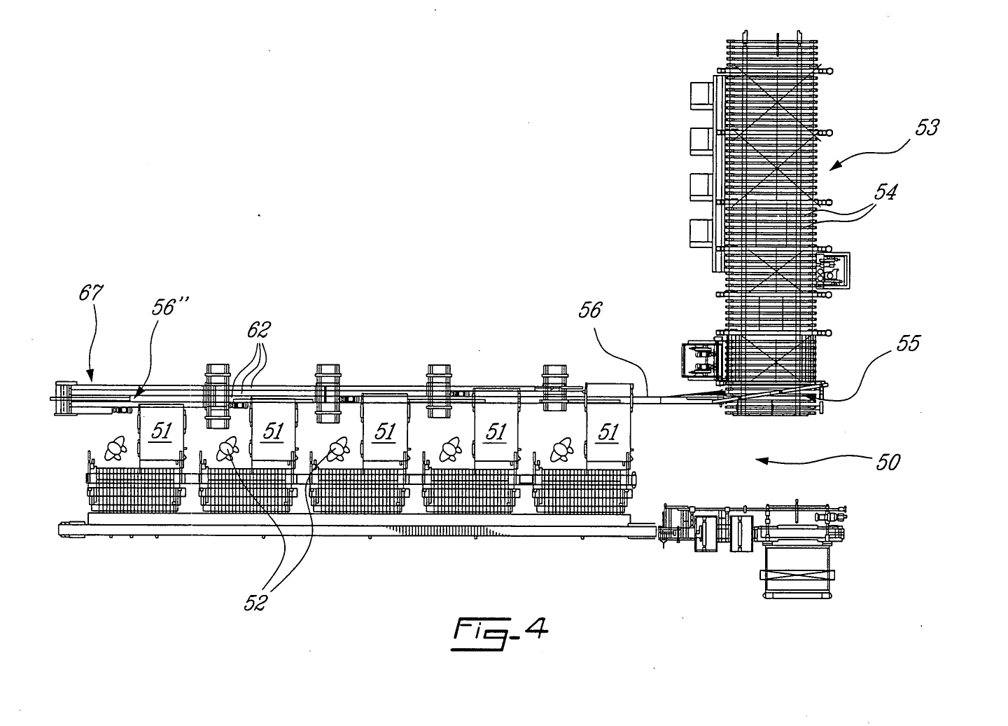

Referring now to FIG. 4, there is shown generally at 50 a conveyor system for feeding elongated articles, such as floorboards, to two or more, herein five, sorting and packaging stations 51. An attendant 52 is associated with each of these stations, whereby to sort the floorboards into their grades, herein three grades, and to form individual bundles of these grades of boards. Such sorting and packaging stations are well known in the art.

As herein shown, a continuous supply conveyor 53 conveys these boards by pusher bars 54, with the boards laterally oriented in spaced parallel relationship. A discharge conveyor 55 engages individual ones of these articles positioned between adjacent pusher bars, and displaces them axially from the supply conveyor 53 onto a single-feed conveyor 56, wherein the articles are conveyed end to end. This is a departure from prior art system where the boards need to be fed directly to each conveyor associated with each station 51. It was also necessary to transfer articles from a supply conveyor onto another intermediate orienting conveyor, and then again to conveyors to feed individual ones of these sorting and packaging stations 51. This system required the use of additional personnel, and the conveyor arrangement also occupied more floor space. The transfer of these boards was also time-consuming.

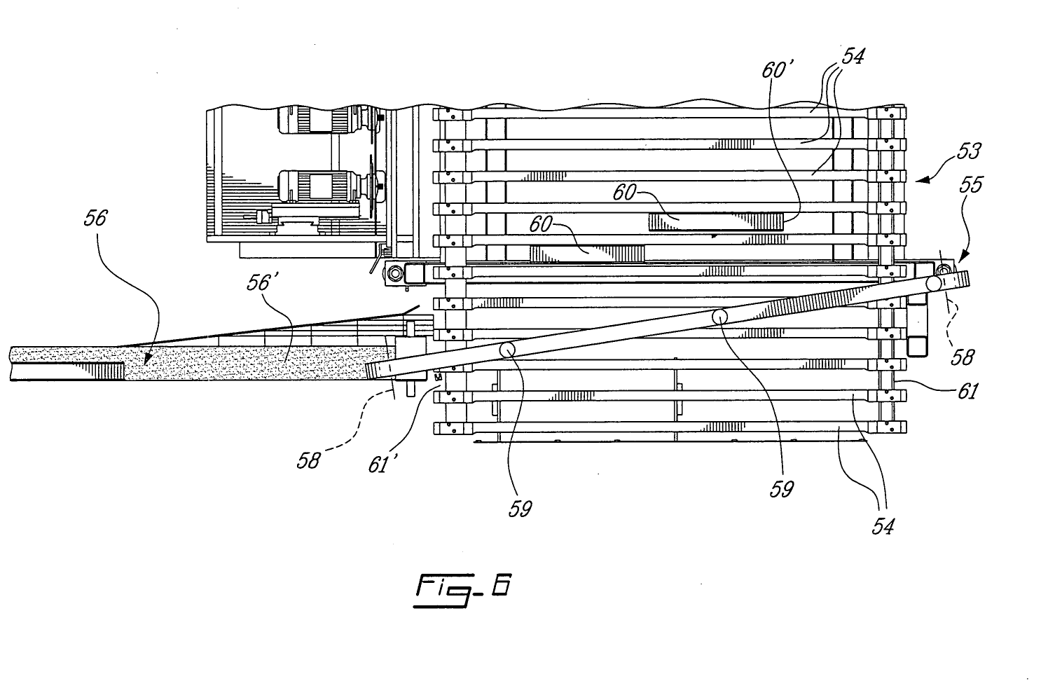

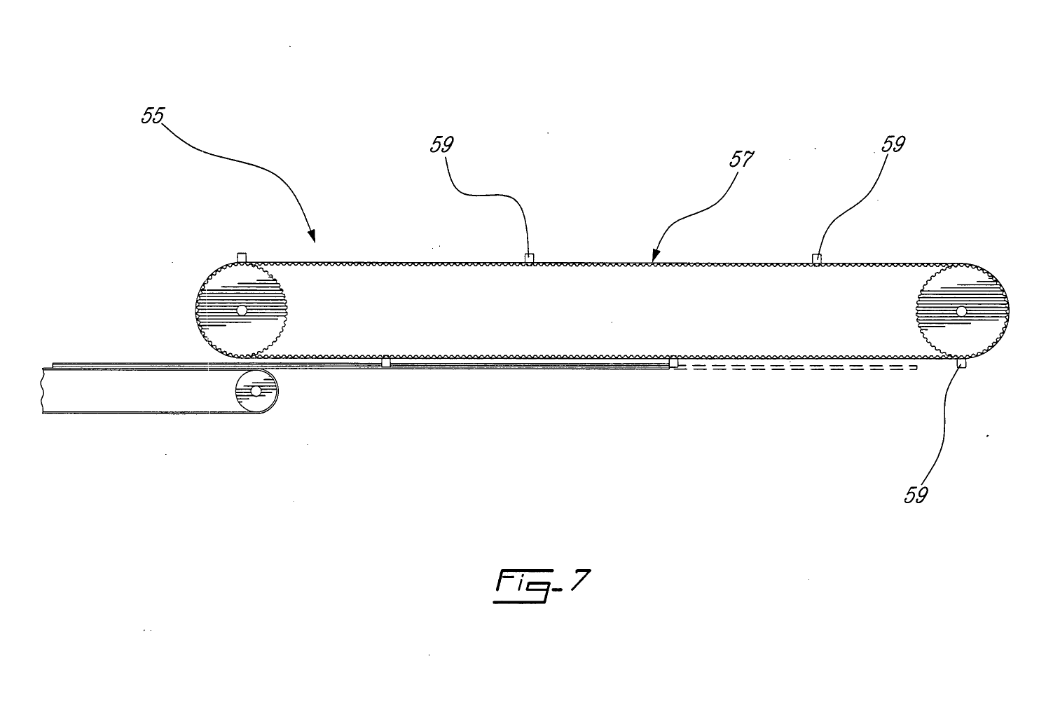

Referring now to Figs and 7, there is shown the construction of the discharge conveyor 55. As shown in FIG. 7, the discharge conveyor is a single driven belt conveyor 57, which is supported by support means 58, schematically illustrated, and oriented at an inclined position elevated a predetermined distance above the supply conveyor 53 and above the pusher bars 54. Pusher lugs 59 are secured to the belt conveyor 57, and project outwardly therefrom. The pusher lugs 59 are spaced apart longitudinally of one another, as illustrated in FIGS. 6 and 7, to project between adjacent ones of the pusher bars 54 of the supply conveyor to pushingly engage an end of an article, herein the end 60′ of floorboard 60, and to push them onto a receiving end 56′ of the single-feed conveyor 56. Again, a controller, such as the controller 25, synchronizes the drive of the discharge conveyor 55 in synchronism with the speed of the supply conveyor 53, whereby the pusher lugs are always intermeshed between the pusher bars 54. These pusher lugs 59 are displaced across the pusher bars 54 and therebetween from an outer edge 61 of the supply conveyor to an inner edge 61′ thereof as the bars 54 advance.

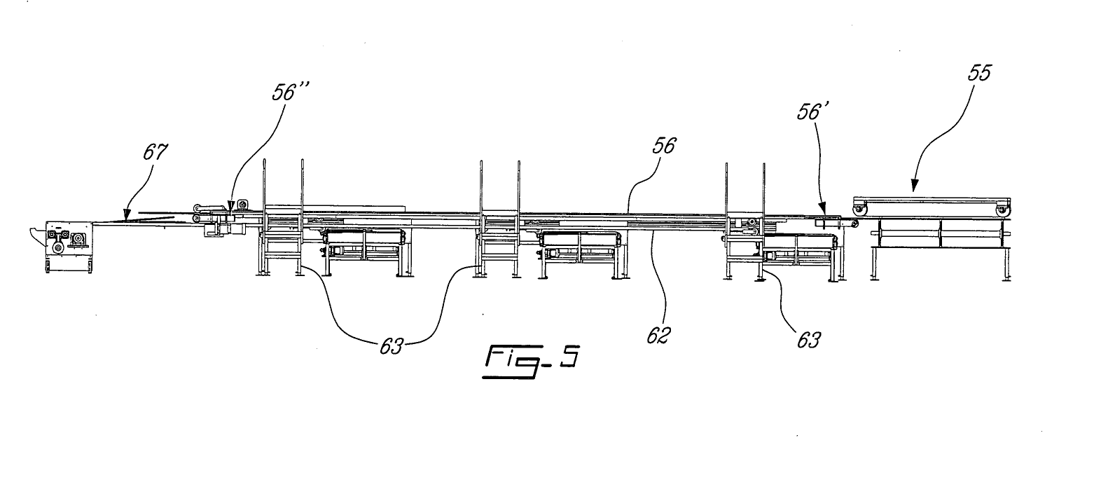

The single-feed conveyor 56 is a narrow belt conveyor to receive floorboards within the full width of conventional floorboards. As previously described, these boards are conveyed end to end from the receiving end 56′ to a discharge end 56″. As shown in FIG. 5, the feed conveyor 56 is supported elevated over two or more, herein five, distribution conveyors 62. Support frames 63 maintain the relative position of these conveyors.

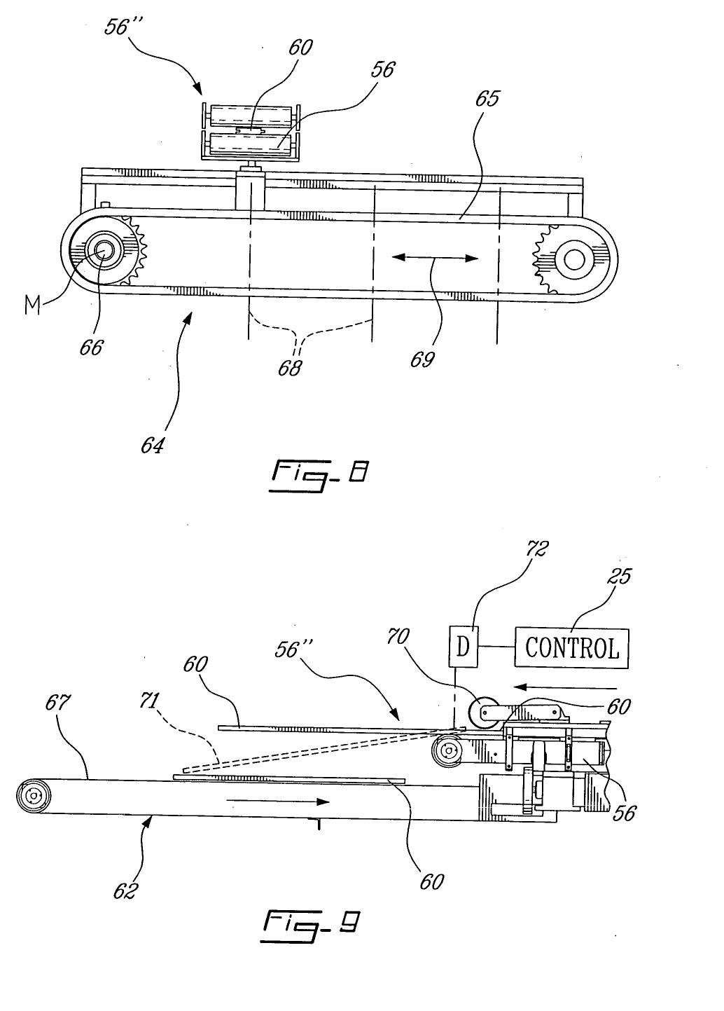

With reference now to FIG. 8, there is illustrated a displacement means 64, which is comprised of a link belt 65 controlled by an indexing motor 66, whereby to displace the discharge end 66″ of the feed conveyor 56 elevated above a receiving end section 67 of each of the distribution conveyors, as shown in the top view in FIG. 4. These positions are illustrated by the axial planes 68 in FIG. 8, and the boards 60 are discharged continuously as the discharge end is displaced back-and-forth, as illustrated by arrow 69 of the link belt. The indexing motor 66 is also controlled by the controller device 25. The boards are fed to the distribution conveyors 62 in substantially equal amounts, as the supply conveyor 58 is usually fed by a jointer device which feeds boards of various lengths, but the overall distribution to the stations 51 results in substantially equal quantities of floorboard lengths being fed to form bundles. In any event, the feed of boards is substantially nonstop to these sorting and bundling stations.

As shown in FIG. 9, the discharge end 56″ of the supply conveyor 56 is provided with an idle roll 70, secured to the frame of the supply conveyor and spaced thereabove whereby to engage a top face 60″ of each board 60 to retard their fall, as illustrated in phantom lines at 71. A detector 72 detects the presence of each board and feeds the information to the controller device 25. This permits the synchronization of the displacement of the supply conveyor, and also provides a count of the number of boards discharged. The detector 72 could also be capable of detecting the length of each of the boards being discharged onto the receiving end section 67 of the distribution conveyor 62. The distribution conveyor 62 may also operate at a slower speed if the discharge end is displaced each time a board is ejected, although this is not essential, as the supply conveyor could be synchronized to discharge a certain number of boards on each of the receiving end sections 67 of the distribution conveyors.

It is within the ambit of the present invention to cover any obvious modifications of the preferred embodiment described herein, provided such modifications fall within the scope of the appended claims.

I claim:

1. A transfer conveyor system for transferring conveyed articles from a lateral conveyed position to an axial conveyed position, said transfer conveyor,system having a reciprocating discharge support platform for discharging, by gravity, a group of articles conveyed by pusher bars of a continuous-feed conveyor, said pusher bars being disposed in spaced alignment and displaceable over said discharge support platform, said articles being discharged by gravity during a detracting displacement of said discharge support platform and onto a conveyor belt oriented transversely to a direction of travel of said pusher bars wherein said group of discharged articles are conveyed axially in a spaced-apart relationship, and means to reciprocate said support platform.

2. A transfer conveyor system as claimed in claim 1, wherein said reciprocating discharge support platform is comprised of a rectangular frame having a plurality of equidistantly spaced elongated support rods secured thereto and extending axially of said continuous-feed conveyor and transversely of said pusher bars, said frame being connected to a crank arm of a reciprocating motor drive constituting said means to reciprocate said support platform.

3. A transfer conveyor system as claimed in claim 2, wherein said continuous-feed conveyor is further provided with an article support section disposed adjacent and upstream of said reciprocating discharge support platform and disposed in a common plane therewith for supporting oncoming articles to be discharged by said reciprocating discharge support platform.

4. A transfer conveyor system as claimed in claim 3, wherein said article support section is comprised of a plurality of equidistantly spaced elongated stationary support rods offset from said support rods of said reciprocating support platform whereby to permit displacement of said support rods of said discharge support platform therebetween.

5. A transfer conveyor system as claimed in claim 3, wherein said crank arm is connected to an output shaft of a servomotor, said servomotor being controlled by a controller to generate a variable-speed drive whereby said discharge support platform is retracted during an accelerating motion and returned during a decelerated motion of a drive cycle for support engagement of said next oncoming group of articles.

6. A transfer conveyor system as claimed in claim 5, wherein said decelerated motion displaces said discharge support platform at substantially the same speed as said pusher bars of said continuous-feed conveyor.

7. A transfer conveyor system as claimed in claim 5, wherein said continuous-feed conveyor is provided with an article loading section upstream of said article support section for receiving articles onto said loading section transversely of said feed conveyor and between said pusher bars at a receiving end thereof, article support means under said pusher bars at said article loading section.

8. A transfer conveyor system as claimed in claim 7, wherein said articles are floorboards of varying lengths, said floorboards being oriented flat and fed axially by a supply conveyor onto said loading section between said pusher bars to convey said floorboards in a lateral position, there being up to six boards discharged in said group of boards and up to about 175 to about 180 boards discharged per minute.

9. A transfer conveyor system as claimed in claim 8, wherein said controller controls the drives of said supply conveyor, said continuous-feed conveyor, said conveyor belt and said servomotor, in synchronism.

10. A transfer conveyor system as claimed in claim 8, wherein said conveyor belt transfers said discharged floorboards onto a discharge transfer apparatus having individual compartments for maintaining each board in said group of boards oriented in a substantially spaced side-by-side relationship.

11. A transfer conveyor system as claimed in claim 5, wherein an end portion of said support rods of said discharge support platform overlap with an end portion of said stationary support rods of said article support section a distance sufficient to provide for said discharge support platform to be retracted and returned to supportingly engage said articles of said next oncoming group of articles.

12. A transfer conveyor system as claimed in claim 7, wherein abutment means are secured between said pusher bars at an end remote from said receiving end of said pusher bars.

13. A transfer conveyor system as claimed in claim 5, wherein said crank arm has a connecting arm portion immovably secured to said output shaft of said servomotor, and a pivotal link arm pivotally connected at one end to a free end of said crank arm portion and at an opposed end to a pivot connection of an outermost transverse frame member of said rectangular frame, said connecting arm portion being displaced about said output shaft at a variable speed.

14. A transfer conveyor system as claimed in claim 3, wherein said continuous-feed conveyor comprises a pair of spaced-apart endless belts trained about driven and idle sprockets secured to a rectangular support frame, said pusher bars being connected to said belts and extending thereacross, said belts having upper and lower spaced parallel travel paths, said conveyor belt being supported by said rectangular support frame between said upper and lower spaced parallel travel paths.

15. A distribution conveyor system for feeding elongated articles to two or more sorting and packaging stations, said system comprising a continuous supply conveyor for conveying said articles by pusher bars oriented laterally in spaced parallel relationship, a discharge conveyor for engaging individual ones of said articles and displacing them axially from said supply conveyor onto a single-feed conveyor wherein said articles are conveyed end to end, said feed conveyor having a discharge end, means to support said feed conveyor elevated above two or more distribution conveyors, each said distribution conveyor being associated with a respective one of said two or more packaging stations, and displaceable support means for displacing at least said discharge end of said feed conveyor to discharge one or more of said articles on a receiving end of a selected one of said distribution conveyors.

16. A distribution conveyor system as claimed in claim 15, wherein said articles are floorboards of varying lengths and quality, said packaging stations being sorting and bundling stations.

17. A distribution conveyor system as claimed in claim 15, wherein said single-feed conveyor is a narrow belt conveyor.

18. A distribution conveyor system as claimed in claim 15, wherein there is further provided detection means for detecting and providing signals to a controller for actuating said displaceable support means to feed substantially equal quantities of said articles to each said distribution conveyor.

19. A distribution conveyor system as claimed in claim 18, wherein said displaceable support means comprises an indexing motor having a timing belt secured to a displaceable support secured to said discharge end of said feed conveyor.

20. A distribution conveyor system as claimed in claim 15, wherein said discharge conveyor comprises a driven belt conveyor supported above an end portion of said supply conveyor and oriented at an inclined position, pusher lugs projecting outwardly of said belt conveyor, said pusher lugs being spaced apart longitudinally of one another to project between adjacent ones of said pusher bars of said supply conveyor to pushingly engage an end of an article conveyed by each said pusher bar to push them onto a receiving end of said feed conveyor, and synchronized drive means to synchronize the speed of said driven belt conveyor relative to said supply conveyor and said feed and distribution conveyors.

21. A distribution conveyor system as claimed in claim 20, wherein said pusher lugs are displaced across said pusher bars and therebetween from an outer edge of said supply conveyor to an inner edge, said receiving end of said feed conveyor being positioned adjacent said inner edge.

22. A feed conveyor system for feeding floorboards to two or more sorting and bundling stations, said system comprising a single-feed conveyor having a board receiving end and board discharge end, means to position boards of varying lengths in spaced-apart end-to-end relationship on said feed conveyor receiving end, distribution conveyors disposed side by side and associated with a respective one of said sorting and bundling stations, support means for supporting said feed conveyor elevated above said distribution conveyors, displacement means for displacing at least a portion of said feed conveyor discharge end above said distribution conveyors for feeding boards thereto to supply said sorting and bundling stations, detection means for detecting boards conveyed by said feed conveyor, and control means associated with said detection means to control the operation of said displacement means.

23. A distribution conveyor system as claimed in claim 22, wherein said boards are floorboards of varying grades and lengths.

24. A distribution conveyor system as claimed in claim 25, wherein said displacement means positions said discharge end above a board receiving end section of said distribution conveyor to eject one or more boards thereon oriented axially of said distribution conveyors, said boards being fed to said distribution conveyors in substantially equal amounts.

25. A distribution conveyor system as claimed in claim 24, wherein said displacement means is an indexing driven element to position said feed conveyor discharge end in a sequential displacement over said receiving end sections of said distribution conveyors.

26. A distribution conveyor system as claimed in claim 24, wherein said detection means is a detector device located at said discharge end of said feed conveyor to detect each board discharged at said discharge end.

27. A distribution conveyor system as claimed in claim 22, wherein said means to position boards at said feed conveyor receiving end is constituted by a discharge conveyor which conveys boards axially from a supply conveyor conveying said boards oriented laterally in spaced-apart relationship.
